(19) United States
(12) Patent Application Publication
(10) Pub. No.: US 2025/0270113 A1
(43) Pub. Date: Aug. 28, 2025

(54) PURIFIED WATER TANK ASSEMBLY

(71) Applicant: COWAY Co., Ltd., Gongju-si (KR)

(72) Inventors: Jae Hoon KIM, Gongju-si (KR); Jung Hwan LEE, Gongju-si (KR); Young Kwang CHOI, Gongju-si (KR); Jin Woo CHOI, Gongju-si (KR); Moyoung GU, Gongju-si (KR)

(73) Assignee: COWAY Co., Ltd., Gongju-si (KR)

(21) Appl. No.: 19/064,874

(22) Filed: Feb. 27, 2025

(30) Foreign Application Priority Data
Feb. 29, 2024 (KR) 10-2024-0030054

(51) Int. Cl. C02F 1/00

(52) U.S. Cl. CPC C02F 1/001; C02F 2201/004; C02F 2209/42

(57) ABSTRACT

A purified water tank assembly is disclosed. A purified water tank assembly according to one aspect of the present disclosure includes a purified water tank having a tank space formed therein, a sensor assembly detachably coupled to the purified water tank so as to be disposed to be at least partially exposed to the tank space, and a sensor coupling member coupled to the purified water tank and disposed to surround the sensor assembly coupled to the purified water tank, in which the purified water tank includes a tank body surrounding the tank space, a cover coupling portion constituting an upper end portion of the tank body and coupled to an external cover, and a sensor supporting portion positioned on a lower side of the cover coupling portion, communicating the tank space with the outside, and coupled to the sensor coupling member, and the sensor coupling member is configured to close the sensor support portion when the sensor assembly is introduced into the tank space and when the sensor assembly is withdrawn from the tank space.

### CROSS-REFERENCE TO RELATED APPLICATIONS

This application claims the priority of Korean Patent Application No. KR10-2024-0030054 filed on Febrary 28, 2024, in the Korean Intellectual Property Office, the disclosure of which is incorporated herein by reference.

### BACKGROUND

### Field

The present disclosure relates to a purified water tank assembly, and more specifically, to a purified water tank assembly having a structure in which a sensor may be replaced without a draining process.

### Description of the Related Art

A water purifier is a general term for any device that may receive raw water, process the raw water into a desired state of a user, and then provide the processed water to the user. The water purifier may filter raw water using various types of filters and provide the filtered water to the user. For example, the water purifier may filter raw water to make the raw water suitable for drinking and provide the filtered water to the user.

As living standards improve and user demands diversify, water purifiers that may perform additional functions in addition to simply filtering raw water to provide purified water have recently become popular. For example, water purifiers that may provide hot water, cold water, and even ice to users have recently been released and are selling well.

Typically, a water purifier for discharging cold water includes a tank for accommodating purified water and has a configuration for cooling the purified water contained in the tank. The above-mentioned type of water purifier may be referred to as a tank-type water purifier. The tank-type water purifier is widely used because they may discharge a large amount of cold water at once.

At this time, the tank has a means for measuring the temperature of the generated cold water or purified water. This is to detect whether the temperature of the generated cold water or purified water corresponds to a desired temperature of the user, and prevent purified water or cold water of an unintended temperature from being discharged.

Meanwhile, cold water at a lower temperature is located lower than the purified water at a relatively higher temperature due to the density difference according to temperature. In addition, the cold water located at the lower side in the accommodated cold water due to the structure of the tank is provided to the outside relatively first. Therefore, it is preferable that the above configuration be located adjacent to the lower side among the positions of the tank.

The above configuration includes an electronic device. Therefore, as the use of the water purifier continues, there may be cases where maintenance of the above configuration is required. In this case, the process of discharging the purified water or cold water contained in the tank should be performed first so that the replacement work of the above configuration may be performed without unintended leakage.

When the above process is performed by a skilled worker, there is little chance of problems occurring during the drainage process and the replacement process of the above configuration. Meanwhile, when unskilled worker or a general user performs the above process, there is a possibility that the purified water or cold water may leak unintentionally in a case where the replacement process of the above configuration is performed in a state where the purified water or cold water has not been sufficiently drained.

Korean Utility Model No. 20-0117910 discloses a water purifier. Specifically, the water purifier is disclosed in which a temperature sensor for detecting the temperatures of cold water and hot water is detachably provided so that the temperature sensor may be easily replaced.

However, the temperature sensor disclosed in the above-mentioned prior document is coupled with a hot water tank and a cold-water tank by a separate coupling member such as a screw. In other words, the above-mentioned prior document only proposes a method for providing a temperature sensor in a detachable manner and does not provide a method for replacing the temperature sensor without a process of draining the hot water or cold water filling the hot water tank or the cold-water tank.

Korean Patent Publication No. 10-2004-0046124 discloses a temperature detector protection tube replacement device. Specifically, the present disclosure discloses a temperature detector protection tube replacement device capable of preventing fluid leakage from a temperature detector protection tube when the temperature detector protection tube is broken.

However, the temperature detector protection tube replacement device disclosed in the above prior document is assumed to be installed in a pipe, not a tank. Therefore, it is difficult to equally apply the temperature detector protection tube replacement device disclosed in the above prior document to a tank, or the like.

Furthermore, the sensor disclosed in the above prior document is also coupled to the pipe by a separate nipple and socket. The above prior document does not provide a method for easily coupling and separating the sensor, as well as for coupling and decoupling the sensor without a separate drainage process.

### PRIOR ART

### Patent Document

Korean Utility Model Registration No. 20-0117910 (Nov. 19, 1996)

Korean Patent Publication No. 10-2004-0046124 (Jun. 5, 2004)

### SUMMARY

The present disclosure is intended to solve the above problems, and an object of the present disclosure is to provide a purified water tank assembly having a structure in which a sensor may be replaced without a separate drainage process.

Another object of the present disclosure is to provide a purified water tank assembly having a structure in which even an unskilled worker may easily replace a sensor.

Still another object of the present disclosure is to provide a purified water tank assembly having a structure that is easy to self-maintain.

Still another object of the present disclosure is to provide a purified water tank assembly having a structure in which a component for accommodating a fluid may be reliably sealed during the process of coupling and separating a sensor.

Still another object of the present disclosure is to provide a purified water tank assembly having a structure in which a sensor may be replaced without a mechanism having a complex structure.

The objects of the present disclosure are not limited to the objects mentioned above, and other objects not mentioned will be clearly understood by those skilled in the art to which the present disclosure belongs from the description below.

According to one aspect of the present disclosure, there is provided a purified water tank assembly including: a purified water tank having a tank space formed therein; a sensor assembly detachably coupled to the purified water tank so as to be disposed to be at least partially exposed to the tank space; and a sensor coupling member coupled to the purified water tank and disposed to surround the sensor assembly coupled to the purified water tank, in which the purified water tank includes a tank body surrounding the tank space, a cover coupling portion constituting an upper end portion of the tank body and coupled to an external cover, and a sensor supporting portion positioned on a lower side of the cover coupling portion, communicating the tank space with the outside, and coupled to the sensor coupling member, and the sensor coupling member is configured to close the sensor support portion when the sensor assembly is introduced into the tank space and when the sensor assembly is withdrawn from the tank space.

In this case, the sensor assembly may include a sensor member penetrating the sensor coupling member and the sensor supporting portion and at least partially exposed to the tank space, and the sensor coupling member includes a packing member that surrounds an outer periphery of the sensor member penetrating the sensor supporting portion so that the sensor supporting portion is sealed.

The packing member may include a packing surface formed of a flexible material, and a cut portion positioned inside the packing surface and formed to be cut in a thickness direction of the packing surface.

When the sensor member is penetrated and coupled, the cut portion may be expanded and the packing surface may be deformed toward the tank space to wrap around the outer periphery of the sensor member, and when the sensor member is separated, the packing surface may be deformed so that the cut portion contracts and the packing surface may be deformed toward a side opposite to the tank space to close the sensor support portion.

The sensor supporting portion may include a sensor support housing that supports the sensor assembly and the sensor coupling member radially outward, and a sensor accommodating hollow positioned inside the sensor support housing and formed to penetrate the tank body to communicate with the tank space.

When the sensor member is penetrated and coupled, the sensor accommodating hollow may be closed by the sensor member, and when the sensor member is separated, the sensor accommodating hollow may be closed by the packing surface.

The sensor member, the sensor accommodating hollow, and the packing surface may be formed to have cross sections with corresponding shapes.

The sensor member, the sensor accommodating hollow, and the packing surface may be formed to have a circular cross-section.

The packing surface may be formed as a curved surface rounded to be convex in a direction toward the tank space.

The sensor coupling member may include a cap member positioned between the tank space and the packing member and configured to support the packing member along a longitudinal direction of the packing member.

The sensor coupling member may include a housing that accommodates the packing member and the cap member and supports the packing member and the cap member in a radial direction and in a longitudinal direction, and a sealing member that is coupled to an outer periphery of the housing and configured to seal between the sensor supporting portion and the housing.

The sensor assembly may include a sensor packing member that partially surrounds the outer periphery of the sensor member and is coupled with the sensor member, and is coupled with an inner periphery of the housing to seal between the sensor member and the housing.

The sensor packing member may include a sensor packing body extending in a longitudinal direction of the sensor member and partially wrapping the outer periphery of the sensor member, and a sensor packing protrusion formed to protrude radially from the sensor packing body.

The sensor packing protrusion may be formed so that a protruding length of the sensor packing protrusion decreases along a direction toward the tank space.

The purified water tank may include a water level sensor coupling portion to which a water level sensor is coupled to generate detection information on a level of water contained in the tank space, and the sensor supporting portion may be located below the water level sensor coupling portion.

According to the above configuration, in the purified water tank assembly according to one embodiment of the present disclosure, the sensor can be replaced without a separate drainage process.

In addition, according to the above configuration, in the purified water tank assembly according to one embodiment of the present disclosure, even an unskilled worker can easily replace the sensor.

Moreover, according to the above configuration, in the purified water tank assembly according to one embodiment of the present disclosure, it is easy to self-maintain.

Further, according to the above configuration, in the purified water tank assembly according to one embodiment of the present disclosure, the configuration accommodating the fluid can be reliably sealed during the process of coupling and separating the sensor.

In addition, according to the above configuration, in the purified water tank assembly according to one embodiment of the present disclosure, the sensor can be replaced without a mechanism having complex structure.

It should be understood that the effects of the present disclosure are not limited to the effects described above, but include all effects that can be inferred from the composition of the present disclosure described in the detailed description or claims of the present disclosure.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating a purified water tank assembly according to one embodiment of the present disclosure.

FIG. 2 is a plan view illustrating the purified water tank assembly of FIG. 1.

FIG. 3 is an exploded perspective view illustrating the configuration of the purified water tank assembly of FIG. 1.

FIG. 4 is a front view illustrating a purified water tank provided in the purified water tank assembly of FIG. 1.

FIG. 5 is a side cross-sectional view illustrating the purified water tank of FIG. 4 and taken along line B-B.

FIG. 6 is a perspective view illustrating a sensor assembly provided in the purified water tank assembly of FIG. 1.

FIG. 7 is a side view illustrating the sensor assembly of FIG. 6.

FIG. 8 is a cross-sectional view illustrating the sensor assembly of FIG. 6 and taken along line C-C.

FIG. 9 is a perspective view illustrating a sensor coupling member provided in the purified water tank assembly of FIG. 1.

FIG. 10 is a cross-sectional view illustrating the sensor coupling member of FIG. 9 and taken along line E-E.

FIG. 11 is an exploded perspective view illustrating the configuration of the sensor coupling member of FIG. 10.

FIG. 12 is a side cross-sectional view illustrating a housing provided in the sensor coupling member of FIG. 10.

FIG. 13 is a side cross-sectional view and a rear view illustrating a packing member provided in the sensor coupling member of FIG. 10.

FIG. 14 is a side cross-sectional view illustrating a cap member provided in the sensor coupling member of FIG. 10.

FIG. 15 is a cross-sectional view illustrating the internal configuration of the purified water tank assembly of FIG. 1 and taken along line A-A.

FIG. 16 is a partial cutaway perspective view illustrating an inter-component coupling structure of the purified water tank assembly of FIG. 1.

### DETAILED DESCRIPTION OF THE EMBODIMENT

Hereinafter, with reference to the attached drawings, embodiments of the present disclosure will be described in detail so that those with ordinary skill in the art may easily practice the present disclosure. The present disclosure may be implemented in various different forms and is not limited to the embodiments described herein. In order to clearly describe the present disclosure, parts that are not related to the description are omitted in the drawings, and the same reference numerals are assigned to the same or similar components throughout the specification.

The words and terms used in this specification and claims should not be construed as limited to their usual or dictionary meanings, but should be interpreted as having meanings and concepts consistent with the technical idea of the present disclosure, in accordance with the principles by which the inventor may define terms and concepts in order to best describe his or her invention.

Therefore, the embodiments described in this specification and the configurations illustrated in the drawings correspond to preferred embodiments of the present disclosure and do not represent all of the technical ideas of the present disclosure, so that the corresponding configurations may have various equivalents and modified examples that may replace them at the time of filing of the present disclosure.

In the following description, descriptions of some components may be omitted to clarify the features of the present disclosure.

The term “communicating” as used in the following description means that one or more members are connected to each other in a fluidic manner. In one embodiment, the communication may be formed by members such as conduits, pipes, or tubing. In the following description, the communication may be used to mean that one or more members are “fluidically connected” to each other.

The term “conduction” used in the following description means that one or more members are connected to each other so that the members may transmit current or electrical signals. In one embodiment, the conduction may be in the form of a wire, such as by a conductor, or in the form of a wireless communication, such as Bluetooth, Wi-Fi, RFID, or the like. In one embodiment, the conduction may include the meaning of “communication”.

The term “fluid” used in the following description means any form of material that flows due to an external force and may change shape or volume, or the like. In one embodiment, the fluid may be a liquid such as water or a gas such as air.

The terms “upper side”, “lower side”, “left side”, “right side”, “front side”, and “rear side” used in the following description are to be understood with reference to the coordinate system depicted throughout the accompanying drawings.

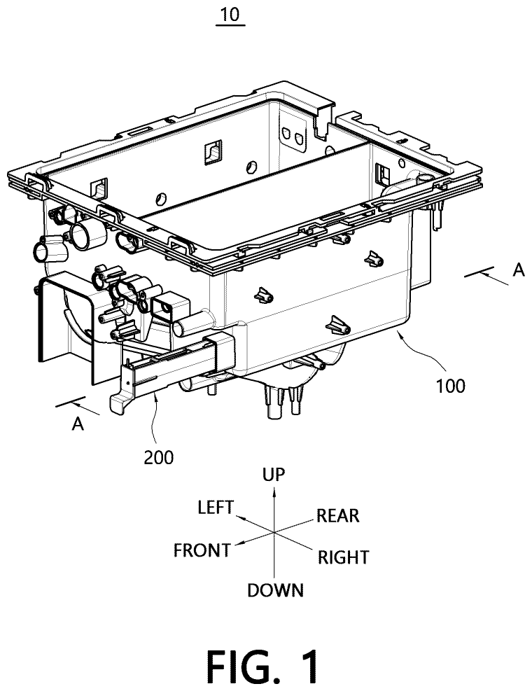

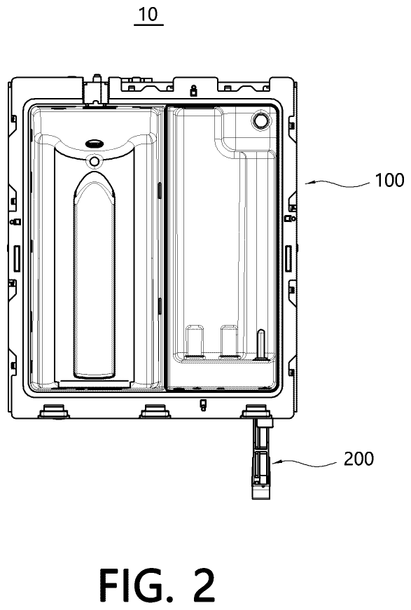

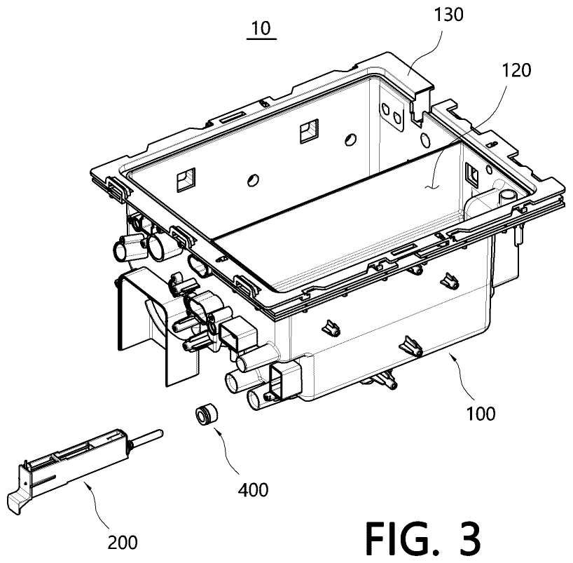

Referring to FIGS. 1 to 3, a purified water tank assembly 10 according to an embodiment of the present disclosure is illustrated. The purified water tank assembly 10 according to an embodiment of the present disclosure may be installed and utilized in any device requiring storage of fluid. In one embodiment, the purified water tank assembly 10 may be installed and utilized in a water purifier, a water dispenser, or the like.

The purified water tank assembly 10 may accommodate any fluid that needs to be provided externally according to the request of a user. In one embodiment, the purified water tank assembly 10 may accommodate at least one of purified water, cold water, and hot water. When the purified water tank assembly 10 accommodates fluids of different temperatures, a partitioned space may be formed inside the purified water tank assembly 10 so that fluids of different temperatures are not randomly mixed.

The purified water tank assembly 10 may include any configuration for detecting information about the state of the accommodated fluid. In one embodiment, the purified water tank assembly 10 may include a configuration for detecting a temperature of the accommodated fluid and a configuration for detecting a water level of the accommodated fluid.

In this case, the purified water tank assembly 10 may be configured so that the above configuration may be separated or coupled without discharging the accommodated fluid to the outside. Accordingly, the process of separating or coupling the above configuration may be easily performed. Since the accommodated fluid does not need to be discharged, a process for regenerating the fluid is also not required, so that user convenience may be improved.

In the illustrated embodiment, the purified water tank assembly 10 includes a purified water tank 100, a sensor assembly 200, and a sensor coupling member 400.

The purified water tank 100 constitutes the outer shape of the purified water tank assembly 10. A space is formed inside the purified water tank 100 to accommodate the fluid. In one embodiment, the fluid may be filtered water or cold water obtained by cooling filtered water.

The purified water tank 100 is coupled with a sensor assembly 200. The sensor assembly 200 may be detachably coupled to the purified water tank 100. The sensor assembly 200 may be at least partially exposed to a space formed inside the purified water tank 100 and may detect any information about the state of the fluid contained in the space.

The purified water tank 100 is coupled with the sensor coupling member 400. Specifically, the purified water tank 100 may be detachably coupled with the sensor assembly 200 by the sensor coupling member 400. As will be described later, the space formed inside the purified water tank 100 may be sealed by the sensor coupling member 400 during the process of the coupling and separating of the sensor assembly 200. Accordingly, the process of the coupling and separating of the sensor assembly 200 may be performed without the drainage process of the purified water or cold water contained in the purified water tank 100.

The purified water tank 100 communicates with the outside. The filtered water or cold water in which the filtered water has been cooled may be introduced into the purified water tank 100. In addition, the purified water or the cold water accommodated in the purified water tank 100 may be provided to the outside according to the request of the user.

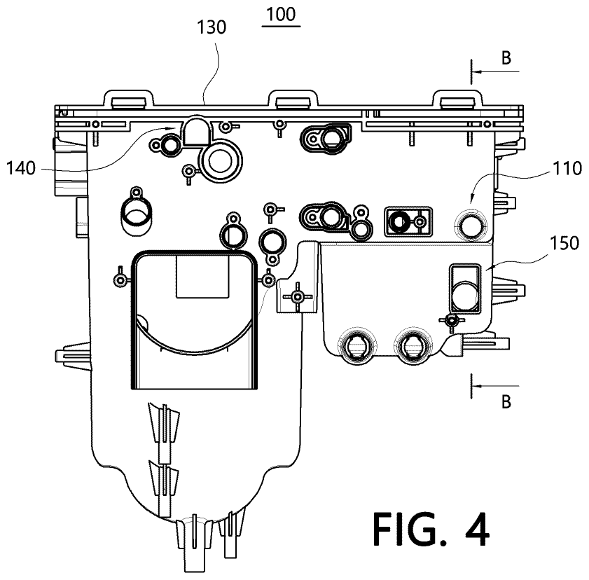

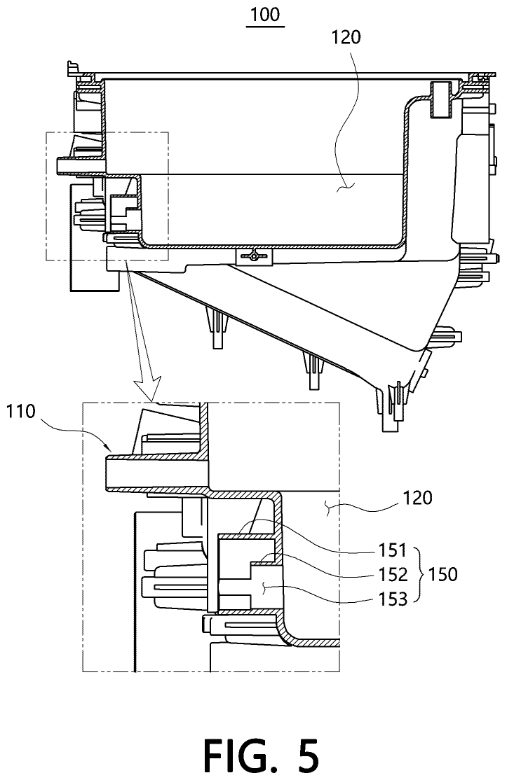

In the embodiment illustrated in FIGS. 4 and 5, the purified water tank 100 includes a tank body 110, a tank space 120, a cover coupling portion 130, a water level sensor coupling portion 140, and a sensor supporting portion 150.

The tank body 110 constitutes the body of the purified water tank 100. Other configurations of the purified water tank 100 may be formed in or coupled to the tank body 110. In the illustrated embodiment, the tank space 120 is formed inside the tank body 110. In addition, the cover coupling portion 130, the water level sensor coupling portion 140, and the sensor support portion 150 are formed in or coupled to the tank body 110.

The tank body 110 may constitute the outer shape of the purified water tank 100 and have any shape in which other configurations of the purified water tank 100 may be formed. In the illustrated embodiment, the tank body 110 is a three-dimensional shape in which a length in the front-rear direction is longer than a width in a left-right direction and which has height in an up-down direction.

The tank body 110 surrounds the tank space 120 in a plurality of directions. The tank body 110 surrounds the tank space 120 on each side in a longitudinal direction, each side in the width direction, and one side in the height direction, that is, a front side, a rear side, a left side, a right side, and a lower side in the illustrated embodiment.

The other side of the tank body 110 in the height direction, the upper side in the illustrated embodiment, is defined as the cover coupling portion 130. The other side of the tank body 110 in the height direction is coupled with a cover (not illustrated).

A water level sensor coupling portion 140 and a sensor supporting portion 150 are formed to penetrate one side of the tank body 110 in the longitudinal direction, that is, the front side in the illustrated embodiment.

The tank space 120 is a space formed inside the tank body 110. The tank space 120 may accommodate any fluid, for example, the purified water or cold water. The tank space 120 communicates with the outside to receive and accommodate the purified water or cold water, and may provide the purified water or cold water to the outside according to the request of the user.

The tank space 120 is defined by being surrounded by the inner periphery of the tank body 110. As described above, the tank space 120 is defined by each side in the longitudinal direction, each side in the width direction, and one side in the height direction being surrounded by the inner periphery of the tank body 110.

The other side of the tank space 120 in the height direction, that is, the upper side in the illustrated embodiment, is formed as open. The upper side of the tank space 120 may be covered by a cover (not illustrated). Accordingly, foreign substances, or the like may be prevented from entering the purified water or cold water contained in the tank space 120.

The tank space 120 may have a shape corresponding to the shape of the tank body 110. In the illustrated embodiment, the tank space 120 is formed as a three-dimensional space having a length in the front-rear direction longer than a width in the left-right direction and a height in the up-down direction.

The tank space 120 communicates with the outside by a water level sensor coupling portion 140 and a sensor support portion 150. A water level sensor (not illustrated) and the sensor assembly 200 may penetrate the water level sensor coupling portion 140 and the sensor support portion 150 and be at least partially exposed to the tank space 120.

In an embodiment where the tank space 120 accommodates both the purified water and cold water, the tank space 120 may be partitioned into a plurality of spaces that accommodate the purified water and cold water. To this end, the tank space 120 may be provided with a bulkhead member (not given a drawing symbol).

The cover coupling portion 130 is a portion where a cover (not illustrated) covering the other side, that is, the upper side, in the height direction of the tank space 120 is coupled. The cover coupling portion 130 is defined as the other side, that is, the upper edge, in the height direction of the tank body 110.

The cover coupling portion 130 may be positioned above the water level sensor coupling portion 140 and the sensor support portion 150 to be described later. In other words, the cover coupling portion 130 is positioned above the water level sensor (not illustrated) coupled to the water level sensor coupling portion 140 and the sensor assembly 200 coupled to the sensor support portion 150.

The cover coupling portion 130 may be provided in any shape that may be removably coupled with the cover (not illustrated). In the illustrated embodiment, the cover coupling portion 130 is defined as the upper edge of the tank body 110.

The cover coupling portion 130 may have a shape corresponding to the shape of the horizontal cross-section of the tank body 110. In the illustrated embodiment, the cover coupling portion 130 is configured to include a pair of surfaces extending in the front-rear direction and spaced apart in the left-right direction, and another pair of surfaces extending in the left-right direction and spaced apart in the front-rear direction and continuous with the pair of surfaces.

A water level sensor coupling portion 140 is located below the cover coupling portion 130.

The water level sensor coupling portion 140 is a portion to which a water level sensor (not illustrated) that generates detection information on the water level of the purified water or cold water contained in the tank space 120 is coupled. The water level sensor coupling portion 140 is formed to penetrate the tank body 110 and the tank space 120 communicates with the outside through the water level sensor coupling portion. The water level sensor (not illustrated) may be coupled to penetrate the water level sensor coupling portion 140. The water level sensor (not illustrated) may be positioned to be at least partially exposed to the tank space 120.

The water level sensor coupling portion 140 may be formed at any location where the water level sensor (not illustrated) is coupled. In the illustrated embodiment, the water level sensor coupling portion 140 is formed to penetrate one side of the tank body 110 in the longitudinal direction, that is, the front side in the illustrated embodiment.

The water level sensor coupling portion 140 may be positioned between the cover coupling portion 130 and the sensor supporting portion 150 along the height direction of the tank body 110. In this case, the water level sensor coupling portion 140 may be positioned closer to the cover coupling portion 130 located at the uppermost side.

The sensor supporting portion 150 is a portion to which the sensor assembly 200 which generates temperature detection information for the purified water or cold water contained in the tank space 120 is coupled. The sensor supporting portion 150 is formed in the tank body 110, and includes a configuration in which the sensor supporting portion penetrates the tank body 110.

The tank space 120 communicates with the outside through the sensor supporting portion 150. Some components of the sensor assembly 200 may be coupled to penetrate the sensor supporting portion 150. Some components of the sensor assembly 200 may be positioned so as to be at least partially exposed to the tank space 120.

The sensor supporting portion 150 may be formed at any location where the sensor assembly 200 may be coupled. In the illustrated embodiment, the sensor supporting portion 150 is formed to penetrate one side of the tank body 110 in the longitudinal direction, the front side in the illustrated embodiment.

The sensor supporting portion 150 may be positioned at the lowest side along the height direction of the tank body 110. In other words, the sensor supporting portion 150 may be positioned opposite the cover coupling portion 130. Accordingly, the sensor assembly 200 coupled with the sensor supporting portion 150 may generate detection information on the temperatures of the purified water or cold water located at the lower side of the tank space 120.

The sensor supporting portion 150 is coupled with the sensor coupling member 400. The sensor assembly 200 may be coupled with and supported by the sensor supporting portion 150 through the sensor coupling member 400. That is, the sensor coupling member 400 and the sensor supporting portion 150 may be sequentially disposed in the radial direction centered on the sensor assembly 200.

In this case, the sensor supporting portion 150 may be sealed by the sensor coupling member 400. That is, in a state where the sensor assembly 200 is coupled or separated, the sensor supporting portion 150 may be sealed by the sensor coupling member 400. In addition, even during the process of coupling or separating the sensor assembly 200, the sensor supporting portion 150 may be sealed by the sensor coupling member 400.

Accordingly, in any case, the purified water or cold water contained in the tank space 120 may not leak out to the outside. A detailed description of this will be provided later.

In the illustrated embodiment, the sensor supporting portion 150 includes a first sensor support housing 151, a second sensor support housing 152, and a sensor accommodating hollow 153.

The first sensor support housing 151 supports the sensor assembly 200 from the radial outside. The first sensor support housing 151 supports a sensor housing 210 provided in the sensor assembly 200 from the outside.

The first sensor support housing 151 may have any shape that may support the sensor housing 210 from the outside. In the illustrated embodiment, the first sensor support housing 151 has a three-dimensional shape with a rectangular cross section and a length in the front-rear direction corresponding to the outer shape of the sensor housing 210.

A hollow is formed inside the first sensor support housing 151, and the hollow extends in the longitudinal direction, in the front-rear direction in the illustrated embodiment. The second sensor support housing 152 and the sensor accommodating hollow 153 are positioned in the hollow. The first sensor support housing 151 surrounds the second sensor support housing 152 and the sensor accommodating hollow 153 radially outwardly.

The second sensor support housing 152 supports the sensor coupling member 400 from the radially outer side. The second sensor support housing 152 is coupled with the housing 420 and the sealing member 430 provided in the sensor coupling member 400. The space between the second sensor support housing 152 and the sensor coupling member 400 may be sealed by the sealing member 430.

The second sensor support housing 152 may have a shape corresponding to the shapes of the housing 420 and the sealing member 430 of the sensor coupling member 400. In the illustrated embodiment, the second sensor support housing 152 has a three-dimensional shape with a circular cross-section and a length in the front-rear direction.

A sensor accommodating hollow 153 is formed penetrating through the interior of the second sensor support housing 152 in the longitudinal direction, that is, in the front-rear direction in the illustrated embodiment. The second sensor support housing 152 surrounds the sensor accommodating hollow 153 and the sensor coupling member 400 coupled to the sensor accommodating hollow in the radial direction.

The sensor accommodating hollow 153 is a portion into which the sensor assembly 200 is penetrated and connected. The sensor member 220 of the sensor assembly 200 may penetrate the sensor accommodating hollow 153 and be exposed to the tank space 120. The sensor accommodating hollow 153 is formed to penetrate the lower side of the front side of the tank body 110.

The sensor accommodating hollow 153 is formed inside the second sensor support housing 152. The radially outer side of the sensor accommodating hollow 153 is defined by being surrounded by the second sensor support housing 152. The sensor accommodating hollow 153 is formed to extend in the longitudinal direction of the second sensor support housing 152, in the front-rear direction in the illustrated embodiment. Each side of the sensor accommodating hollow 153 in the longitudinal direction, that is, the front side and the rear side in the illustrated embodiment, are respectively formed to be open.

The sensor coupling member 400 is coupled to the sensor accommodating hollow 153. The sensor accommodating hollow 153 may be sealed by a packing member 440 formed in the sensor coupling member 400. In addition, the space between the housing 420 accommodated in the sensor accommodating hollow 153 and the second sensor support housing 152 may be sealed by a sealing member 430.

The sensor accommodating hollow 153 may have any shape that may be penetratingly coupled with the sensor coupling member 400 and the sensor member 220. In the illustrated embodiment, the sensor accommodating hollow 153 is formed as a cylindrical space having a circular cross-section and a length in the front-rear direction corresponding to the shapes of the sensor coupling member 400 and the sensor member 220.

The sensor assembly 200 generates any detection information about the state of the purified water or cold water contained in the purified water tank 100. The sensor assembly 200 may be configured to include any sensor capable of generating any detection information about the state of the purified water or cold water.

In one embodiment, the sensor assembly 200 may generate detection information about the temperature of the purified water or cold water. In the above embodiment, the sensor assembly 200 may be configured to include a temperature sensor.

Additionally, the sensor assembly 200 may generate detection information on the water level of the purified water or cold water contained in the purified water tank 100. In the above embodiment, the sensor assembly 200 may be configured to include a water level sensor.

Furthermore, the sensor assembly 200 may generate detection information on the pH concentration, turbidity, chlorine (Cl) concentration, or the like of the purified water or cold water contained in the purified water tank 100. In the above embodiment, the sensor assembly 200 may be configured to include a water quality sensor.

The sensor assembly 200 may be removably coupled to the purified water tank 100. Specifically, the sensor assembly 200 may be removably coupled to the sensor supporting portion 150 so as to be at least partially exposed to the tank space 120.

The sensor assembly 200 may be removably coupled with the sensor coupling member 400. The sensor assembly 200 is tightly coupled with the sensor coupling member 400, so that the tank space 120 may be sealed in a state of being coupled with or separated from the purified water tank 100. Furthermore, the sensor assembly 200 may be sealed in the tank space 120 in the process in which the sensor assembly is coupled with or separated from the purified water tank 100 by the sensor coupling member 400.

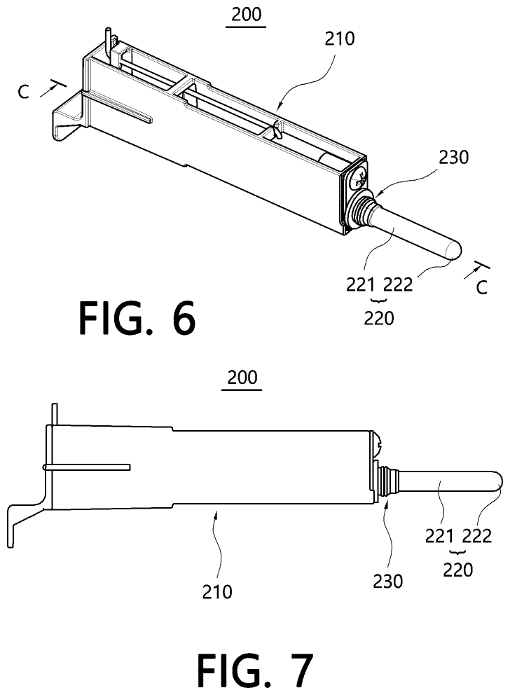

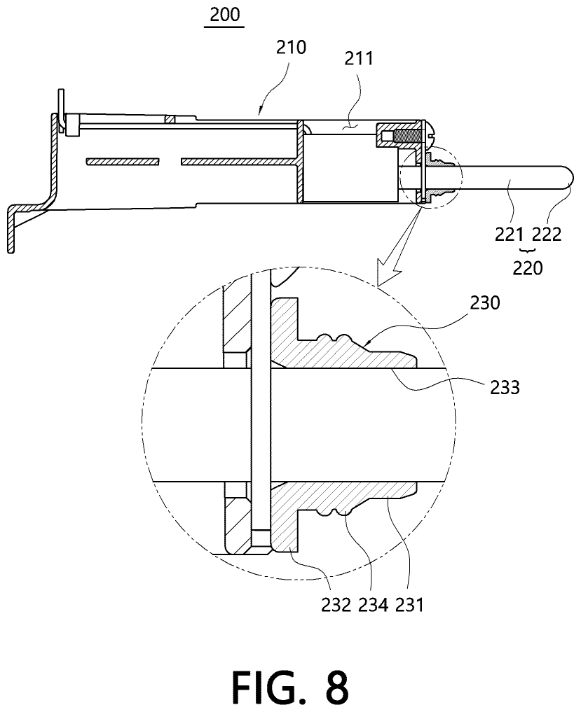

In the embodiments illustrated in FIGS. 6 to 8, the sensor assembly 200 includes the sensor housing 210, the sensor member 220, and a sensor packing member 230.

The sensor housing 210 constitutes a portion of the outer shape of the sensor assembly 200. The sensor housing 210 is coupled with other components of the sensor assembly 200 to support the components. In the illustrated embodiment, the sensor housing 210 is coupled with the sensor member 220 to support the sensor member. The sensor housing 210 may be penetrably coupled with the sensor member 220.

The sensor housing 210 may be formed to have a length in the direction in which the sensor assembly 200 is coupled with or separated from the purified water tank 100. In the illustrated embodiment, the sensor housing 210 is formed to have a length in the front-rear direction.

The sensor housing 210 is coupled with the first sensor support housing 151. Specifically, the sensor housing 210 is accommodated in a space defined by being surrounded by the first sensor support housing 151, and a radially outer side of the sensor housing is supported by the first sensor support housing 151.

The sensor housing 210 may have a shape corresponding to the shape of the first sensor support housing 151. In the illustrated embodiment, the sensor housing 210 has a three-dimensional shape with a rectangular cross-section and is extended in the front-rear direction.

In the illustrated embodiment, the sensor housing 210 includes a sensor accommodating space 211.

The sensor accommodation space 211 is a space formed inside the sensor housing 210. The sensor accommodation space 211 partially accommodates the sensor member 220 that is penetrably coupled to the sensor housing 210.

The sensor accommodation space 211 may have a shape corresponding to the shape of the sensor housing 210. In the illustrated embodiment, the sensor accommodation space 211 is formed as a polygonal prism-shaped space having a rectangular cross-section and a length in the front-rear direction.

The sensor member 220 generates detection information about the state of purified water or cold water contained in the tank space 120. In one embodiment, the sensor member 220 may generate the detection information about the temperature of the purified water or cold water contained in the tank space 120.

The sensor member 220 is coupled with the sensor supporting portion 150. Specifically, the sensor member 220 is coupled with the sensor coupling member 400, is supported radially outwardly by the second sensor support housing 152, and is penetrably coupled to the sensor accommodating hollow 153.

The sensor member 220 is disposed so as to be at least partially exposed to the tank space 120. The sensor member 220 may come into contact with the purified water or cold water contained in the tank space 120 to generate the above-described detection information.

The sensor member 220 is electrically connected to the outside. The detection information generated by the sensor member 220 may be transmitted to a control unit (not illustrated).

The sensor member 220 is coupled with the sensor housing 210. The sensor member 220 is coupled to penetrate one side of the sensor housing 210 in the longitudinal direction, the rear side in the illustrated embodiment, and is at least partially accommodated in the sensor accommodation space 211.

The sensor member 220 is coupled with the sensor packing member 230. The sensor packing member 230 is coupled to penetrate the sensor member 220.

In the illustrated embodiment, the sensor member 220 includes a sensor body 221 and a sensor end portion 222.

The sensor body 221 constitutes the body of the sensor member 220. The sensor body 221 is a portion where the sensor member 220 is coupled with the sensor housing 210 and the sensor packing member 230. In addition, the sensor body 221 is a portion which is coupled with the sensor coupling member 400.

As will be described later, the packing member 440 of the sensor coupling member 400 may surround the outer periphery of the sensor body 221. Accordingly, the sensor accommodating hollow 153 may be sealed, thereby blocking any communication between the tank space 120 and the outside.

The sensor body 221 may have a shape corresponding to the sensor accommodating hollow 153, the sensor packing member 230, or the packing member 440. In the illustrated embodiment, the sensor body 221 has a cylindrical shape with a circular cross-section and a length in the front-rear direction.

One end portion of the sensor body 221 in the extension direction, the front-end portion in the illustrated embodiment, is located in the sensor accommodating space 211. The other end portion of the sensor body 221 in the extension direction, the rear end portion in the illustrated embodiment, is defined as the sensor end portion 222.

The sensor end portion 222 is a portion of the configuration of the sensor member 220 that is exposed to the tank space 120. The sensor end portion 222 is defined as the other end portion of the sensor body 221, that is, the end portion on the rear side.

The sensor end portion 222 may penetrate the sensor accommodating hollow 153 and the packing member 440 and be positioned in the tank space 120. In order for the sensor end portion 222 to be easily coupled with and separated from the packing member 440, the sensor end portion 222 may have a curved shape rounded to be convex toward the direction toward the tank space 120, that is, toward the front side in the illustrated embodiment.

The sensor packing member 230 is configured to seal the space formed between the sensor assembly 200 and the sensor coupling member 400. The sensor packing member 230 seals the sensor accommodating hollow 153 multiple times together with the sealing member 430 and the packing member 440 provided in the sensor coupling member 400.

Accordingly, the purified water or cold water contained in the tank space 120 may not arbitrarily leak out through the sensor accommodating hollow 153.

The sensor packing member 230 is coupled with the sensor member 220. Specifically, the sensor packing member 230 is penetrably coupled with the sensor member 220. The sensor packing member 230 is positioned so as to be biased toward one side of the sensor member 220 in the longitudinal direction, that is, toward the front side in the illustrated embodiment. The sensor packing member 230 may be supported by contacting one side of the sensor housing 210 in the longitudinal direction, that is, toward the front side in the illustrated embodiment.

In the illustrated embodiment, the sensor packing member 230 includes a sensor packing body 231, a sensor packing base 232, a sensor packing hollow 233, and a sensor packing protrusion 234.

The sensor packing body 231 constitutes the body of the sensor packing member 230. Other configurations of the sensor packing member 230 may be coupled to or formed in the sensor packing body 231. In the illustrated embodiment, the sensor packing body 231 is coupled with the sensor packing base 232 and is continuous. The sensor packing hollow 233 is formed penetratingly in the interior of the sensor packing body 231, and the sensor packing protrusion 234 is formed to protrude from the outer periphery of the sensor packing body 231.

The sensor packing body 231 may have a shape corresponding to the shape of the sensor member 220 or a housing hollow 423 formed inside the housing 420 of the sensor coupling member 400. In the illustrated embodiment, the sensor packing body 231 is formed in a cylindrical shape having a circular cross-section and a length in the front-rear direction.

In this case, an outer diameter of the cross-section of the sensor packing body 231 may be formed to decrease in the direction opposite to the sensor housing 210, that is, from the front side to the rear side. In other words, the outer diameter of the cross-section on one side of the sensor packing body 231 in the longitudinal direction, that is, the front side, is formed to be larger than the outer diameter of the cross-section on the other side in the longitudinal direction, that is, the rear side. In this case, the outer diameter of the cross-section of the sensor packing body 231 may be formed to be equal to or less than the diameter of the cross-section of the housing hollow 423.

Accordingly, the sensor packing member 230 may be easily coupled with the housing 420.

The sensor packing body 231 is coupled with the sensor packing base 232.

The sensor packing base 232 is a portion where the sensor packing member 230 comes into contact with the sensor housing 210. The sensor packing base 232 is supported by contacting one side of the sensor housing 210 in the longitudinal direction, the front side in the illustrated embodiment.

The sensor packing base 232 is continuous with the sensor packing body 231. In the illustrated embodiment, the sensor packing base 232 is continuous with one side of the sensor packing body 231 in the longitudinal direction, that is, the front side.

The sensor packing base 232 may have a shape corresponding to the shape of the sensor packing body 231 or housing 420. In the illustrated embodiment, the sensor packing base 232 has a disk shape having a circular cross-section and a thickness in the front-rear direction.

In this case, the outer diameter of the cross-section of the sensor packing base 232 may be formed to exceed the outer diameter of the cross-section of the housing hollow 423. That is, the sensor packing base 232 may not be accommodated in the housing hollow 423, but may be supported by contacting one side of the housing body 421 in the longitudinal direction, that is, the front side in the illustrated embodiment.

By the above contact, the length at which the sensor assembly 200 is coupled to the purified water tank 100 may be limited.

The sensor packing hollow 233 is a space that accommodates the sensor body 221. The sensor packing hollow 233 is formed penetratingly in the interiors of the sensor packing body 231 and the sensor packing base 232, respectively. Among the portions of the sensor packing hollow 233, the portion formed inside the sensor packing body 231 and the portion formed inside the sensor packing base 232 communicate with each other.

The sensor packing hollow 233 may have a shape corresponding to the shape of the sensor body 221 or the sensor packing body 231. In the illustrated embodiment, the sensor packing hollow 233 is formed as a cylindrical space having a circular cross-section and a length in the front-rear direction.

In the above embodiment, the diameter of the cross-section of the sensor packing hollow 233 may be formed to be equal to or less than the diameter of the cross-section of the sensor body 221. Accordingly, the sensor packing member 230 and the sensor body 221 may be fitting-coupled, so that the sensor packing member 230 and the sensor member 220 may not be arbitrarily separated.

The sensor packing protrusion 234 is a portion where the sensor packing member 230 is in contact with the inner periphery of the housing body 421. The sensor packing protrusion 234 is configured to seal the housing hollow 423. Accordingly, the sensor accommodating hollow 153 is sealed multiple times, so that any leakage of purified water or cold water contained in the tank space 120 may be prevented.

The sensor packing protrusion 234 is formed in the sensor packing body 231. Specifically, the sensor packing protrusion 234 is formed to protrude radially outward from the outer periphery of the sensor packing body 231. The sensor packing protrusion 234 extends along the outer periphery of the sensor packing body 231. That is, the sensor packing protrusion 234 is formed as a ring-shaped protrusion.

In this case, the sensor packing protrusion 234 may be protruded so that an end portion in the radial direction is in contact with the inner periphery of the housing 420. In other words, the outer diameter of the cross-section of the sensor packing protrusion 234 may be formed to be equal to or more than the diameter of the cross-section of the housing hollow 423. In the above embodiment, the sensor packing member 230 may be fitting-coupled with the housing 420, so that the housing hollow 423 may be effectively sealed.

A plurality of sensor packing protrusions 234 may be provided. The plurality of sensor packing protrusions 234 are spaced apart in the longitudinal direction of the sensor packing body 231 and may each be in close contact with the inner periphery of the housing 420. In the illustrated embodiment, a pair of sensors packing protrusions 234 are provided and spaced apart in the front-rear direction.

The sensor coupling member 400 is coupled to the purified water tank 100 and the sensor assembly 200. The sensor coupling member 400 is positioned at the coupling portion of the purified water tank 100 and the sensor assembly 200, and is configured to seal the tank space 120. That is, the sensor coupling member 400 mediates the coupling between the purified water tank 100 and the sensor assembly 200.

The sensor coupling member 400 is coupled with the purified water tank 100. Specifically, the sensor coupling member 400 is coupled with the sensor supporting portion 150. The sensor coupling member 400 is accommodated in the sensor accommodating hollow 153 and the outer periphery of the sensor coupling member is supported by the second sensor supporting housing 152. The sensor coupling member 400 may be disposed to be at least partially exposed to the tank space 120. The sensor coupling member 400 is configured to seal the sensor accommodating hollow 153.

In this case, the sensor coupling member 400 may seal the sensor accommodating hollow 153 in a state where the sensor assembly 200 is coupled with or separated from the purified water tank 100. In addition, the sensor coupling member 400 may seal the sensor accommodating hollow 153 in the process in which the sensor assembly 200 is coupled with or separated from the purified water tank 100. That is, the sensor coupling member 400 is configured to constantly seal the sensor accommodating hollow 153.

In addition, the sensor coupling member 400 may seal the sensor accommodating hollow 153 without a complex structure such as a valve including a configuration for mechanical operation such as a spring or a plate. Specifically, the sensor coupling member 400 may seal the sensor accommodating hollow 153 by the water head pressure formed by purified water or cold water contained in the tank space 120.

At the same time, the sensor coupling member 400 may be detachably coupled to the sensor assembly 200. The above process may be performed simply by moving the sensor assembly 200 toward the sensor coupling member 400 or by moving the sensor assembly 200 away from the sensor coupling member 400.

Therefore, in order to attach the sensor assembly 200 to the purified water tank 100 or separate the sensor assembly from the purified water tank 100, the purified water or cold water contained in the tank space 120 does not need to be drained. In addition, the process of coupling the sensor assembly 200 to the purified water tank 100 or separating the sensor assembly from the purified water tank 100 may be easily performed.

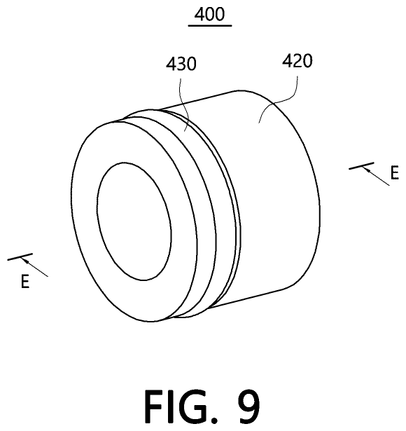

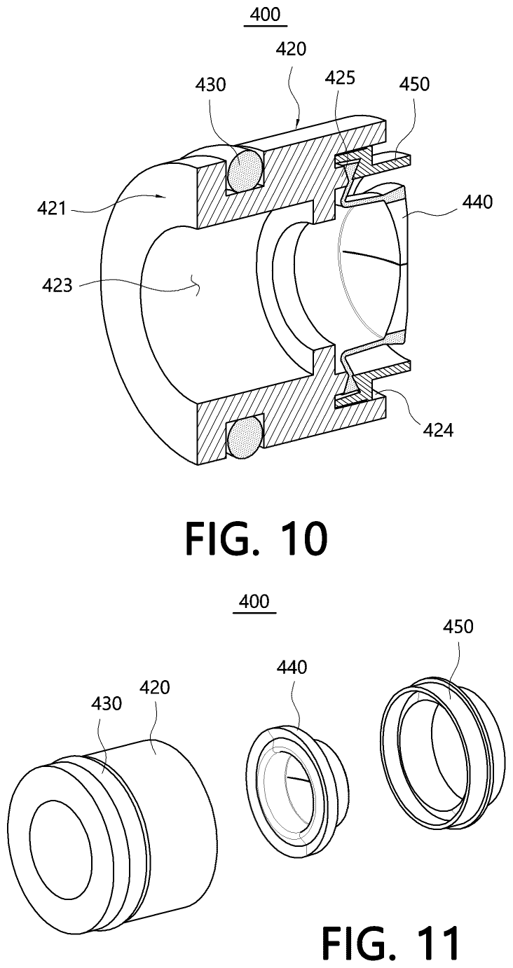

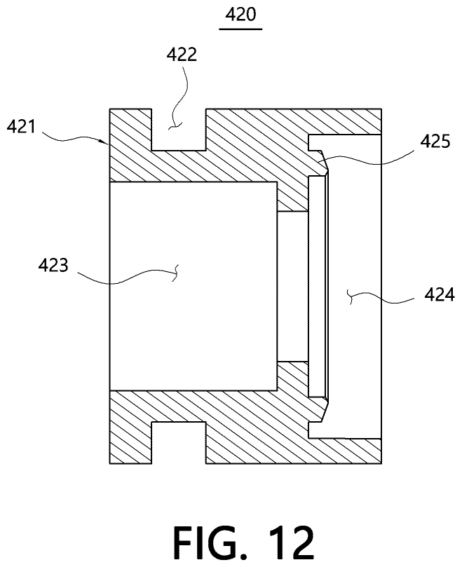

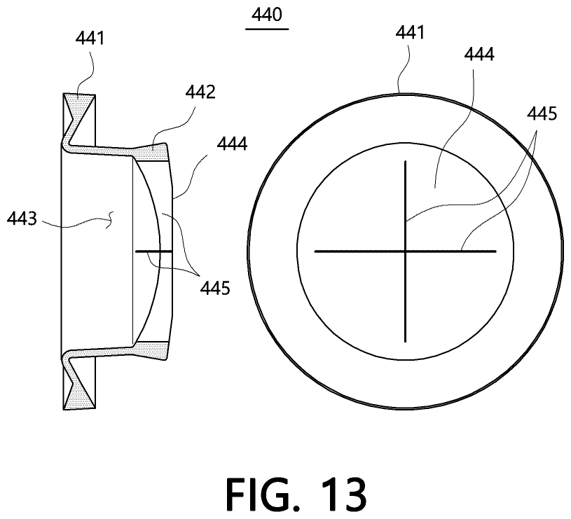

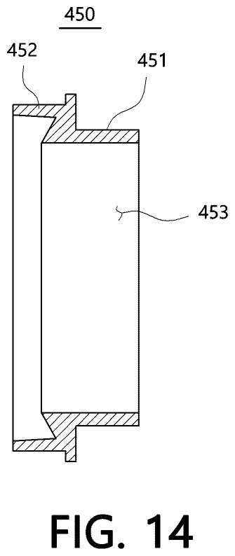

In the embodiments illustrated in FIGS. 9 to 14, the sensor coupling member 400 includes the housing 420, the sealing member 430, the packing member 440, and a cap member 450.

The housing 420 constitutes a part of the sensor coupling member 400. The housing 420 is a portion where the sensor coupling member 400 is coupled to the sensor supporting portion 150. The housing 420 is accommodated in the sensor accommodating hollow 153 and the outer periphery of the housing is supported by the second sensor support housing 152.

The housing 420 is coupled with the sensor assembly 200. The sensor member 220 is penetrably coupled to the housing 420 and the sensor packing member 230 is accommodated in the housing.

The housing 420 is coupled with the sealing member 430. The sensor accommodating hollow 153 that accommodates the housing 420 may be sealed by the sealing member 430.

The housing 420 is coupled with the packing member 440. The housing 420 has one side in the longitudinal direction, that is, the front side in the illustrated embodiment, coupled with the packing member 440 to support the packing member.

The housing 420 is coupled with the cap member 450. The packing member 440 may be maintained to be coupled with the housing 420 by the cap member 450. In the illustrated embodiment, the cap member 450 is disposed facing the housing 420 with the packing member 440 interposed therebetween.

In the illustrated embodiment, the housing 420 includes the housing body 421, a sealing member coupling groove 422, the housing hollow 423, a packing member coupling hollow 424, and a packing member supporting protrusion 425.

The housing body 421 constitutes the outer shape of the housing 420. Other components of the housing 420 are formed in or coupled to the housing body 421. In the illustrated embodiment, the sealing member coupling groove 422, the housing hollow 423, the packing member combining hollow 424, and the packing member supporting protrusion 425 are formed in the housing body 421.

Specifically, the sealing member coupling groove 422 is formed to be recessed in the outer periphery of the housing body 421. The housing hollow 423 is penetrably formed in the interior of the housing body 421. The packing member coupling hollow 424 is formed to penetrate one side of the housing body 421 in the longitudinal direction, that is, the rear side in the illustrated embodiment, and a packing member supporting protrusion 425 is formed.

The housing body 421 is coupled with the sensor assembly 200 and supports the sensor assembly. Specifically, the housing body 421 supports the sensor packing member 230 accommodated in the housing hollow 423 from the radially outer side.

In addition, a portion of the inner periphery of the housing body 421 in which the housing hollow 423 and the packing member coupling hollow 424 are continuous may be formed to protrude radially inwardly compared to other portions. The portion may support the outer periphery of the sensor body 221.

The housing body 421 may have any shape that allows other configurations of the housing 420 to be formed and coupled with the sensor assembly 200 to support the sensor assembly. In the illustrated embodiment, the housing body 421 has a cylindrical shape with a circular cross-section and a length in the front-rear direction.

In the above embodiment, the outer diameter of the cross-section of the housing body 421 may be formed to be the same as the diameter of the cross-section of the sensor accommodating hollow 153.

The sealing member coupling groove 422 is formed to be recessed in the outer periphery of the housing body 421.

The sealing member coupling groove 422 is a portion where the housing 420 is coupled to the sealing member 430. The sealing member coupling groove 422 is formed to be recessed in the outer periphery of the housing body 421. The sealing member coupling groove 422 extends along the housing body 421.

That is, the sealing member coupling groove 422 has an annular cross-section and is formed as a space having a thickness in the front-rear direction. The shape of the sealing member coupling groove 422 may be changed to correspond to the shape of the sealing member 430.

The sealing member coupling groove 422 may be formed at any location capable of accommodating the sealing member 430. In the illustrated embodiment, the sealing member coupling groove 422 is positioned to be biased toward one side of the longitudinal direction of the housing body 421, that is, the front side in the illustrated embodiment.

The housing hollow 423 is defined as a space formed inside the housing body 421. The housing hollow 423 is located on one side of the longitudinal direction of the housing body 421, that is, on the front side in the illustrated embodiment. The housing hollow 423 accommodates the sensor member 220 and the sensor packing member 230 coupled with the sensor member.

The housing hollow 423 may have a shape corresponding to the shape of the housing body 421 or the sensor packing member 230. In the illustrated embodiment, the housing hollow 423 is formed as a cylindrical space having a circular cross-section and a length in the front-rear direction.

In the above embodiment, the diameter of the cross-section of the housing hollow 423 may be formed to be equal to or less than the diameter of the cross-section of the packing member coupling hollow 424. In addition, the diameter of the cross-section of the housing hollow 423 may be formed to be equal to or less than the outer diameter of the cross-section of the sensor packing protrusion 234. Accordingly, the sensor packing protrusion 234 may be in close contact with the inner periphery of the housing body 421 surrounding the housing hollow 423.

One side of the housing hollow 423 in the longitudinal direction, that is, the front side in the illustrated embodiment, is formed open. The sensor member 220 and the sensor packing member 230 may be introduced into or withdrawn from the housing hollow 423 through the one side.

The other side of the housing hollow 423 in the longitudinal direction, the rear side in the illustrated embodiment, is formed open and communicates with the packing member coupling hollow 424. In this case, a protrusion protruding from the inner periphery of the housing body 421 is formed at the portion where the housing hollow 423 and the packing member coupling hollow 424 communicate. As described above, the protrusion supports the sensor body 221.

The packing member coupling hollow 424 is defined as another space formed inside the housing body 421. The packing member coupling hollow 424 is located on the other side in the longitudinal direction of the housing body 421, that is, on the rear side in the illustrated embodiment. The packing member coupling hollow 424 accommodates the packing member 440 and the cap member 450 supporting the packing member.

In this case, the packing member coupling hollow 424 may accommodate the packing member 440 and the cap member 450 to be at least partially exposed to the outside. In other words, the packing member coupling hollow 424 is formed to have a shorter length (that is, length in the front-rear direction) than the packing member 440 and the cap member 450.

The packing member coupling hollow 424 may have a shape corresponding to the shape of the housing body 421, the packing member 440, or the cap member 450. In the illustrated embodiment, the packing member coupling hollow 424 is formed as a cylindrical space having a circular cross-section and a length in the front-rear direction.

In the above embodiment, the diameter of the cross-section of the packing member coupling hollow 424 may be formed to be equal to or more than the outer diameter of the cross-section of the packing member 440 and equal to or less than the outer diameter of the cross-section of the cap member 450. Accordingly, the packing member 440 and the cap member 450 may be maintained in a state in which they are accommodated in the packing member coupling hollow 424.

One side of the packing member coupling hollow 424 in the longitudinal direction, that is, the front side in the illustrated embodiment, is formed open and communicates with the housing hollow 423. The sensor member 220 may be coupled to penetrate the packing member 440 and the cap member 450 accommodated in the packing member coupling hollow 424 through the one side.

The other side of the packing member coupling hollow 424 in the longitudinal direction, the rear side in the illustrated embodiment, is formed open and communicates with the tank space 120. The sensor member 220 may be inserted into the tank space 120 through the other side.

The packing member support protrusion 425 supports the packing member 440 and the cap member 450 radially inwardly. In addition, the radially outer sides of the packing member 440 and the cap member 450 accommodated in the packing member coupling hollow 242 are supported by the inner periphery of the housing body 421.

Accordingly, the coupling state of the packing member 440 and the cap member 450 and the housing 420 may be stably maintained.

The packing member support protrusion 425 is formed in a portion of the inner periphery of the housing body 421 that protrudes from the portion where the housing hollow 423 and the packing member coupling hollow 424 are continuous.

The packing member support protrusion 425 is formed to protrude from the portion of the inner periphery of the housing body 421 toward the purified water tank 100, that is, towards the rear side in the illustrated embodiment. The packing member support protrusion 425 extends along the portion of the inner periphery of the housing body 421.

Accordingly, it will be understood that the packing member support protrusion 425 is formed as an annular protrusion.

The sealing member 430 is in close contact with the inner periphery of the second sensor support housing 152 and the outer periphery of the housing body 421. The sealing member 430 is configured to seal the sensor accommodating hollow 153 that accommodates the sensor coupling member 400.

The sealing member 430 is coupled with the housing 420. Specifically, the sealing member 430 is accommodated in the sealing member coupling groove 422 and supported by the outer periphery of the housing body 421. A hollow is formed inside the sealing member 430 and is penetrably coupled with the housing body 421. That is, the sealing member 430 is formed in an annular shape.

In this case, the outer diameter of the cross-section of the sealing member 430 may be formed larger than the outer diameters of the cross-sections of other portions of the housing body 421. That is, the radially outer end portion of the sealing member 430 is positioned at the most radially outer side among the components of the sensor coupling member 400.

Accordingly, the sealing member 430 may be in close contact with the inner periphery of the second sensor support housing 152 surrounding the sensor accommodating hollow 153 from the radial outer side. As a result, the sensor accommodating hollow 153 is sealed, so that any leakage of the purified water or cold water accommodated in the tank space 120 may be prevented.

The sealing member 430 may be formed of a material having a predetermined elasticity. This is to stably maintain a state of close contact between the inner periphery of the second sensor support housing 152 and the outer periphery of the housing body 421 by the shape deformation and the stored restoring force. In one embodiment, the sealing member 430 may be formed of a rubber or silicone material.

The packing member 440 substantially performs the role of sealing the sensor accommodating hollow 153. The packing member 440 is positioned in the sensor accommodating hollow 153 and may be selectively opened during the process of coupling and separating the sensor member 220. Even in this case, since the packing member 440 is in close contact with the sensor member 220, the sealed state of the sensor accommodating hollow 153 is maintained.

That is, the purified water or cold water accommodated in the tank space 120 by the packing member 440 may not flow out into the sensor accommodating hollow 153.

The packing member 440 is coupled with the sensor member 220. The sensor member 220 may penetrate the packing member 440 and be at least partially exposed to the tank space 120. The packing member 440 may be in close contact with the outer periphery of the sensor member 220 which is penetrably coupled.

The packing member 440 is coupled with the housing 420. The packing member 440 may be accommodated in the sensor accommodating hollow 153 in a state of being coupled with the housing 420. The packing member 440 may be positioned so as to be at least partially exposed to the tank space 120.

The packing member 440 is coupled with the cap member 450. The packing member 440 may be supported in the radial direction and longitudinal direction by the cap member 450.

The packing member 440 may be formed of a material having a predetermined elasticity. Since the packing member is formed of the material having a predetermined elasticity, the packing member 440 is in close contact with the sensor member 220 in a state of storing a restoring force by changing the shape of the packing member during the process of coupling and separating of the sensor member 220, and the packing member is restored to the original shape when the sensor member 220 is separated, thereby sealing the sensor accommodating hollow 153. In one embodiment, the packing member 440 may be formed of a rubber or silicone material.

In the illustrated embodiment, the packing member 440 includes a packing base 441, a packing body 442, a packing hollow 443, a packing surface 444, and a cut portion 445.

The packing base 441 constitutes a portion of the outer shape of the packing member 440. The packing base 441 is a portion where the packing member 440 is supported by the packing member support protrusion 425. In the illustrated embodiment, the packing base 441 constitutes one side of the packing member 440 in the longitudinal direction, that is, the front side.

The packing base 441 may be accommodated in a space formed between the inner periphery of the housing body 421 and the packing member support protrusion 425. The radially inner side of the packing base 441 is supported by the packing member support protrusion 425. The radially outer side of the packing base 441 is supported by the housing coupling protrusion 452 of the cap member 450.

The packing base 441 is continuous with the packing body 442. One side of the packing base 441 in the longitudinal direction, the rear side in the illustrated embodiment, is continuous with the packing body 442. The packing hollow 443 is formed to penetrate the inside of the packing base 441.

The packing base 441 is coupled to the housing 420 and may have any shape that may be supported by the cap member 450. In the illustrated embodiment, the packing base 441 has a three-dimensional shape with a circular cross-section and a length in the front-rear direction, but has an annular cross-section having the packing hollow 443 formed to penetrate the inside of the packing base.

In this case, one side of the outer periphery of the packing base 441, the front side in the illustrated embodiment, is formed to protrude in a direction opposite to the sensor accommodating hollow 153, that is, toward the front side. The one side of the packing base 441 is accommodated in a space formed between the inner periphery of the housing body 421 and the packing member support protrusion 425.

The packing body 442 constitutes another portion of the outer shape of the packing member 440. The packing body 442 is coupled to and supports the packing face 444. In the illustrated embodiment, the packing body 442 constitutes the other side of the packing member 440 in the longitudinal direction, that is, the rear side. The packing body 442 may be at least partially exposed to the tank space 120.

The packing body 442 may be disposed radially apart from the cap body 451 of the cap member 450. By the disposition, sufficient space may be secured for the packing body 442 or the packing surface 444 to be deformed.

The packing body 442 is continuous with the packing base 441. One side of the packing body 442 in the longitudinal direction, the front side in the illustrated embodiment, is continuous with the packing base 441.

The packing hollow 443 is formed to penetrate the inside of the packing body 442. In the portions of the inner periphery of the packing body 442 surrounding the packing hollow 443, one side facing the tank space 120, that is, the rear end portion, is coupled to the packing surface 444.

The packing body 442 is coupled with the packing base 441 and surrounds the packing hollow 443, and may have any shape that may be coupled with the packing surface 444. In the illustrated embodiment, the packing body 442 has an annular cross-section with the packing hollow 443 formed to penetrate the inside of the packing body and has a three-dimensional shape having a length in the front-rear direction.

In the above embodiment, the outer diameter of the cross-section of the packing body 442 may be formed to be equal to or less than the outer diameter of the cross-section of the packing base 441.

The packing hollow 443 is a space formed inside the packing base 441 and the packing body 442. The packing hollow 443 extends in the longitudinal direction of the packing base 441 and the packing body 442, in the front-rear direction in the illustrated embodiment.

The sensor member 220 is inserted into the packing hollow 443. The sensor member 220 may extend through the packing hollow 443 to the tank space 120.

The packing hollow 443 may have any shape capable of accommodating the sensor member 220. In the illustrated embodiment, the packing hollow 443 is formed as a cylindrical space having a circular cross-section and a length in the front-rear direction.

In the above embodiment, one side of the packing hollow 443 in the longitudinal direction, that is, the front side, may be formed open to form a passage for introducing and withdrawing the sensor member 220. The other side of the packing hollow 443 in the longitudinal direction, that is, the rear side, is closed by the packing surface 444.

The packing surface 444 serves to seal the sensor accommodating hollow 153. When the sensor member 220 is coupled with the purified water tank 100, the packing surface 444 may be deformed in a direction toward the tank space 120 by the sensor member 220. In this case, the packing surface 444 is in close contact with the outer periphery of the sensor member 220 to maintain the sensor accommodating hollow 153 in the closed state.

In addition, when the sensor member 220 is coupled with the purified water tank 100, the packing surface 444 that has been deformed is deformed in a direction opposite to the tank space 120 and restored to the original shape of the packing surface. Accordingly, the sensor accommodating hollow 153 is sealed, so that any leakage of the purified water or cold water accommodated in the tank space 120 may be prevented.

The packing surface 444 is coupled with the packing body 442. Specifically, the packing surface 444 is coupled with the other side of the packing body 442 in the longitudinal direction, that is, the rear end portion in the illustrated embodiment. The packing surface 444 seals the packing hollow 443 formed inside the packing body 442 from the other side, that is, the rear side.

The packing surface 444 seals the sensor accommodating hollow 153, but may be of any shape that may be deformed while storing restoring force by the sensor member 220. In the illustrated embodiment, the packing surface 444 is formed as a curved surface that has a circular cross-section and is rounded so as to be convex toward the tank space 120, that is, toward the front side.

In one embodiment, the packing surface 444 may have a shape corresponding to the shape of the sensor member 220 and the sensor accommodating hollow 153.

In the above embodiment, the packing surface 444 may have a stronger resistance to the pressure directed toward the outside of the tank space 120 applied by the purified water or cold water accommodated in the tank space 120. Accordingly, even when the sensor member 220 is separated, the packing surface 444 may maintain the sensor accommodating hollow 153 in the sealed state.

In addition, in the above embodiment, when the sensor member 220 penetrates the cut portion 445 formed in the packing surface 444, the packing surface 444 may be smoothly deformed toward the tank space 120 and may be in close contact with the outer periphery of the sensor member 220. Accordingly, even during the process of coupling and separating the sensor member 220, the packing surface 444 may maintain the sensor accommodating hollow 153 in the sealed state.

The cut portion 445 is formed inside the packing surface 444.

The cut portion 445 may be defined as a slit formed to penetrate the packing surface 444. The packing surface 444 may be divided into a plurality of portions that are continuous with each other but may be independently deformed by the cut portion 445.

When the sensor member 220 is coupled or separated, the plurality of portions of the packing surface 444 may each be deformed based on the cut portion 445. The cut portion 445 penetrates in the thickness direction of the packing surface 444, that is, in the front-rear direction in the illustrated embodiment.

When the sensor member 220 is introduced into the tank space 120, the cut portion 445 expands and the packing surface 444 is deformed so that the packing surface may be in close contact with the outer periphery of the sensor member 220. In addition, when the sensor member 220 is withdrawn from the tank space 120, the cut portion 445 contracts and the packing surface 444 is restored to the original shape of the packing surface so that the sensor accommodating hollow 153 is sealed.

The cut portion 445 may be expanded and contracted by the sensor member 220 and may have any shape that may change the shape of the packing surface 444. In the illustrated embodiment, the cut portion 445 has a cross shape in which one portion extending in the up-down direction and the other portion extending in the left-right direction intersect. The shape of the cut portion 445 may be any shape that may be in close contact with the outer periphery of the sensor member 220 to seal the sensor accommodating hollow 153.

The cap member 450 is coupled with the housing 420 and the packing member 440 to maintain the coupling state between the packing member 440 and the housing 420. The cap member 450 may support the packing member 440.

The cap member 450 is coupled with the housing 420. In the illustrated embodiment, the cap member 450 is partially accommodated in a space formed between the inner periphery on the rear side of the housing 420 and the packing member support protrusion 425. In one embodiment, the cap member 450 may be press-fitting assembled with the housing 420.

The cap member 450 is coupled with the packing member 440. The cap member 450 may support the packing member 440 in the radial direction. In the illustrated embodiment, the cap member 450 supports the packing member 440 radially outward.

The cap member 450 may be formed of a rigid material. This is to stably support the packing member 440 formed of a shape-deformable material. In one embodiment, the cap member 450 may be formed of a polypropylene (PP) material.

In the illustrated embodiment, the cap member 450 includes the cap body 451, the housing coupling protrusion 452, and a cap hollow 453.

The cap body 451 constitutes a part of the outer shape of the cap member 450. The cap body 451 surrounds the packing body 442 radially outwardly. In this case, the cap body 451 may be disposed to be spaced apart from the packing body 442 along the radial direction. Accordingly, a space required for shape deformation of the packing body 442 or the packing surface 444 coupled to the packing body may be secured.

The cap body 451 is coupled with the housing coupling protrusion 452. One side of the cap body 451 in the longitudinal direction, that is, the front side end portion in the illustrated embodiment, is continuous with the housing coupling protrusion 452.

The cap hollow 453 is formed to penetrate the inside of the cap body 451. The cap body 451 may surround the packing member 440 accommodated in the cap hollow 453 from the radial outside.

The cap body 451 surrounds the packing member 440 and may be of any shape that may be coupled to the housing 420 by being coupled with the housing coupling protrusion 452. In the illustrated embodiment, the cap body 451 has an annular cross-section with the cap hollow 453 formed to penetrate the inside of the cap body, and is a three-dimensional shape having a length in the front-rear direction.

The housing coupling protrusion 452 constitutes another part of the outer shape of the cap member 450. The housing coupling protrusion 452 is a part where the cap member 450 is coupled with the housing 420. In addition, the housing coupling protrusion 452 is a part where the cap member 450 supports the packing member 440.

The housing coupling protrusion 452 is continuous with the cap body 451. In the illustrated embodiment, the housing coupling protrusion 452 is continuous with one side of the cap body 451 in the longitudinal direction, that is, the rear side. The housing coupling protrusion 452 extends from the one end portion of the cap body 451 toward the front side.

The cap hollow 453 is formed to penetrate the inside of the housing coupling protrusion 452. The housing coupling protrusion 452 may surround the packing base 441 of the packing member 440 accommodated in the cap hollow 453 from the radial outer side. The radial outer side of the housing coupling protrusion 452 is surrounded by the inner periphery of the housing body 421.

The housing coupling protrusion 452 is coupled with the housing 420. The housing coupling protrusion 452 may be accommodated in a space formed between the inner periphery of the housing body 421 and the packing member support protrusion 425. In one embodiment, as described above, the housing coupling protrusion 452 may be press-fitting assembled to the housing 420.

The cap hollow 453 is a space formed inside the cap member 450. The cap hollow 453 is formed to penetrate the inside of the cap body 451 and the housing coupling protrusion 452. The cap hollow 453 accommodates the packing member 440.

One side of the cap hollow 453 in the longitudinal direction, the front side in the illustrated embodiment, is formed open to form a passage through which the sensor member 220 may be introduced and withdrawn.

The other side of the cap hollow 453 in the longitudinal direction, the rear side in the illustrated embodiment, is formed open to form a passage through which the sensor member 220 may be introduced and withdrawn. In addition, the other side of the cap hollow 453 in the longitudinal direction provides a space for the packing surface 444 to be deformed by expansion and contraction of the cut portion 445.

The cap hollow 453 may be formed in any shape that accommodates the packing member 440, provides the passage for introducing and withdrawing the sensor member 220, and forms a space that may accommodate a shape deformation of the packing member 440. In the illustrated embodiment, the cap hollow 453 is formed as a cylindrical space with a circular cross-section and a length in the front-rear direction.

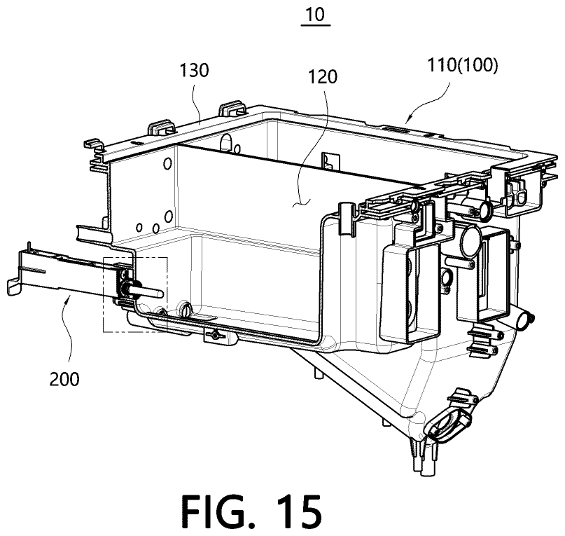

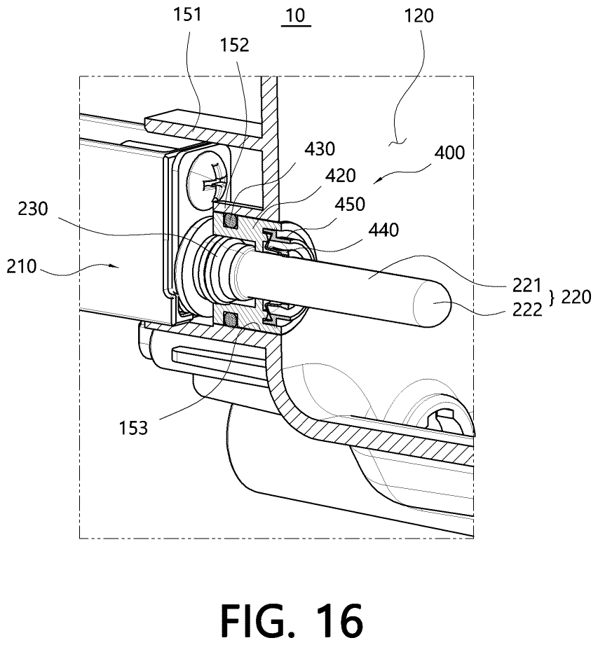

Referring to FIGS. 15 and 16, a state in which the tank space 120 of the purified water tank assembly 10 according to the embodiment of the present disclosure is blocked from communication with the outside regardless of the coupling or separation of the sensor assembly 200 is illustrated as an example.

In the illustrated embodiment, the sensor coupling member 400 is disposed in the sensor accommodating hollow 153. In this case, the packing member 440 and the cap member 450 are positioned so as to be at least partially exposed to the tank space 120.

The inner housing 420 of the sensor coupling member 400 is supported by the inner periphery of the second sensor support housing 152 that radially surrounds the sensor accommodating hollow 153. In this case, the outer periphery of the inner housing 420 may be in contact with the inner periphery of the second sensor support housing 152.

In addition, the sealing member 430 coupled with the inner housing 420 is in close contact with the outer periphery of the inner housing 420 and the inner periphery of the second sensor support housing 152. Accordingly, the sensor accommodating hollow 153 may be sealed.

The sensor member 220 and the sensor packing member 230 coupled to the sensor member are coupled to a housing hollow 423 formed inside the inner housing 420. The sensor packing base 232 is in close contact with one side of the housing body 421 in the longitudinal direction, that is, the front-end portion in the illustrated embodiment. The sensor packing protrusion 234 formed on the outer periphery of the sensor packing body 231 is in close contact with the inner periphery of the housing body 421 surrounding the housing hollow 423 in the radial direction.

Accordingly, the housing hollow 423 may also be sealed.

In addition, the sensor member 220 extends through the packing member 440 and the cap member 450 to the tank space 120. When the sensor member 220 presses the packing surface 444, the cut portion 445 expands and the packing surface 444 is deformed to be in close contact with the outer periphery of the sensor member 220.

Accordingly, the sensor accommodating hollow 153 is sealed by the deformed packing surface 444 and the sensor member 220, so that any leakage of the purified water or cold water accommodated in the tank space 120 may be prevented.

Therefore, in the purified water tank assembly 10 according to the embodiment of the present disclosure, the process of coupling and separating the sensor assembly 200 may be performed without draining the purified water or cold water contained in the tank space 120.

In addition, the tank space 120 is blocked from communication with the outside in multiple stages by the packing member 440, the sealing member 430, and the sensor packing member 230. Accordingly, the airtightness of the tank space 120 may be guaranteed.

Although not illustrated, it will be understood that when the sensor member 220 is withdrawn in the above state, the cut portion 445 is reduced and the packing surface 444 is restored to the original shape, thereby sealing the sensor accommodating hollow 153.

Although the embodiments of the present disclosure have been described, the spirit of the present disclosure is not limited to the embodiments presented in the present specification, and those skilled in the art who understand the spirit of the present disclosure will be able to easily suggest other embodiments by adding, changing, deleting, or adding components within the scope of the same spirit, but this will also be considered to fall within the spirit of the present disclosure.

What is claimed is:

1. A purified water tank assembly comprising:
a purified water tank having a tank space formed therein;
a sensor assembly detachably coupled to the purified water tank so as to be disposed to be at least partially exposed to the tank space; and
a sensor coupling member coupled to the purified water tank and disposed to surround the sensor assembly coupled to the purified water tank,
wherein the purified water tank includes
a tank body surrounding the tank space,
a cover coupling portion constituting an upper end portion of the tank body and coupled to an external cover, and
a sensor supporting portion positioned on a lower side of the cover coupling portion, communicating the tank space with the outside, and coupled to the sensor coupling member, and
the sensor coupling member is configured to close the sensor support portion when the sensor assembly is introduced into the tank space and when the sensor assembly is withdrawn from the tank space.

2. The purified water tank assembly of claim 1, wherein the sensor assembly includes a sensor member penetrating the sensor coupling member and the sensor supporting portion and at least partially exposed to the tank space, and the sensor coupling member includes a packing member that surrounds an outer periphery of the sensor member penetrating the sensor supporting portion so that the sensor supporting portion is sealed.

3. The purified water tank assembly of claim 2, wherein the packing member includes a packing surface formed of a flexible material, and a cut portion positioned inside the packing surface and formed to be cut in a thickness direction of the packing surface.

4. The purified water tank assembly of claim 3, wherein when the sensor member is penetrated and coupled, the cut portion is expanded and the packing surface is deformed toward the tank space to wrap around the outer periphery of the sensor member, and when the sensor member is separated, the packing surface is deformed so that the cut portion contracts and the packing surface is deformed toward a side opposite to the tank space to close the sensor support portion.

5. The purified water tank assembly of claim 3, wherein the sensor supporting portion includes a sensor support housing that supports the sensor assembly and the sensor coupling member radially outward, and a sensor accommodating hollow positioned inside the sensor support housing and formed to penetrate the tank body to communicate with the tank space.

6. The purified water tank assembly of claim 5, wherein when the sensor member is penetrated and coupled, the sensor accommodating hollow is closed by the sensor member, and when the sensor member is separated, the sensor accommodating hollow is closed by the packing surface.

7. The purified water tank assembly of claim 5, wherein the sensor member, the sensor accommodating hollow, and the packing surface are formed to have cross sections with corresponding shapes.

8. The purified water tank assembly of claim 7, wherein the sensor member, the sensor accommodating hollow, and the packing surface are formed to have a circular cross-section.

9. The purified water tank assembly of claim 3, wherein the packing surface is formed as a curved surface rounded to be convex in a direction toward the tank space.

10. The purified water tank assembly of claim 2, wherein the sensor coupling member includes a cap member positioned between the tank space and the packing member and configured to support the packing member along a longitudinal direction of the packing member.

11. The purified water tank assembly of claim 10, wherein the sensor coupling member includes a housing that accommodates the packing member and the cap member and supports the packing member and the cap member in a radial direction and in a longitudinal direction, and a sealing member that is coupled to an outer periphery of the housing and configured to seal between the sensor supporting portion and the housing.

12. The purified water tank assembly of claim 11, wherein the sensor assembly includes a sensor packing member that partially surrounds the outer periphery of the sensor member and is coupled with the sensor member, and is coupled with an inner periphery of the housing to seal between the sensor member and the housing.

13. The purified water tank assembly of claim 12, wherein the sensor packing member includes a sensor packing body extending in a longitudinal direction of the sensor member and partially wrapping the outer periphery of the sensor member, and a sensor packing protrusion formed to protrude radially from the sensor packing body.

14. The purified water tank assembly of claim 13, wherein the sensor packing protrusion is formed so that a protruding length of the sensor packing protrusion decreases along a direction toward the tank space.

15. The purified water tank assembly of claim 1, wherein the purified water tank includes a water level sensor coupling portion to which a water level sensor is coupled to generate detection information on a level of water contained in the tank space, and the sensor supporting portion is located below the water level sensor coupling portion.
